(19) United States
(12) Patent Application Publication
(10) Pub. No.: US 2013/0307366 A1
(43) Pub. Date: Nov. 21, 2013

(54) AXIAL-FLUX ELECTRIC MACHINE

(71) Applicants: Jacob Naginsky, Herzliya (IL); Jonathan Jerby, Herzliya (IL)

(72) Inventors: Jacob Naginsky, Herzliya (IL); Jonathan Jerby, Herzliya (IL)

(73) Assignee: CORIOLIS POWER SYSTEMS LTD., Herzliya (IL)

(21) Appl. No.: 13/980,390

(22) PCT Filed: Jan. 24, 2012
(86) PCT No.: PCT/IL2012/000038

§ 371 Date: Jul. 18, 2013

Related U.S. Application Data
(60) Provisional application No. 61/435,803, filed on Jan. 25, 2011.

(51) Int. Cl. H02K 3/28

(52) U.S. Cl. CPC H02K 3/28
USPC 310/180

(57) ABSTRACT

A stator for an axial-flux electric machine is provided with at least one flat winding formed thereon. The flat winding is circumferentially distributed over the flat stator. The flat winding comprises a plurality of petal-like sections which is substantially radial relative to an axis of the rotor.

### FIELD OF THE INVENTION

The present invention relates to an axial-flux electric machine, and, more specifically, to an electrical machine provided with integral flat winding comprising a plurality of petal-like sections which is substantially radial relative to an axis of said rotor.

### BACKGROUND OF THE INVENTION

Permanent magnet axial-flux machines consist of a number of generally planar rotor disc and stator discs mounted axially along a shaft with each stator and rotor discs separated by a small air-gap (or running clearance). The magnets are mounted circumferentially round the rotor discs with alternating north and south poles facing the stator. The rotor discs rotate relative to the stator discs. The rotor comprises a pair of discs which can have magnets on one or both discs. The stator disc is located between two rotor discs.

The stator disc (core) can be made from a non-magnetic, non-conducting material (coreless type stator) or from a laminated magnetic material (core-type stator). The armature winding is wound on the stator and can be located either in slots or as a surface mounted air-gap winding.

Axial flux machines tend to have a larger diameter and shorter axial length than equivalently radial flux counterparts and therefore tend to be attractive in applications that demand machines of short axial length; for example as in-wheel motors or for use with internal combustion engines when the generator can be mounted directly on the engine in place of the flywheel.

The pan-cake shape geometry and high torque capability make axial flux permanent magnet motors a preferred choice for direct-drive systems. In recent years, many different topologies of axial flux permanent magnet machines have been developed and reported.

U.S. Pat. No. 7,663,279 ('279) discloses a motor module which includes a bearing housing having a loading base, an electric unit, a bearing, and a magnetic rotor unit disposed on the bearing. In addition, a protruding portion is extending from the loading base, and the electric unit includes a printed circuit board (PCB) and sensing elements, wherein the PCB is utilized for disposing the loading base thereon. Moreover, signal circuits and motor windings are formed on the PCB around the loading base, the sensing elements are disposed around the motor windings, and the bearing is disposed at the protruding portion. Besides, the magnetic rotor unit is disposed on the motor windings, keeping a gap with the PCB; therefore, when electric current passes the motor windings, the, magnetic rotor unit and the motor windings generate a flux linkage induction, so as to drive the magnetic rotor unit to rotate relative to the PCB (Abstract).

In accordance with EP 0246671 ('671), in a coreless-brushless motor a frequency generating coil is disposed between the rotor magnet and the stator yoke. The frequency generating coil is so arranged as to induce therein, by magnetic fluxes from the revolving rotor magnet, an AC signal of a frequency proportional to the revolving speed of the rotor magnet. A portion of a drive current to a driving coil block of the motor is branched and, by the branched drive current, current induced in the frequency generating coil by magnetic fluxes of the driving coil block is cancelled in a canceller circuit, from which is derived only the AC signal induced by the magnetic flux of the rotor magnet, thereby detecting its revolving speed (Abstract).

All technical solutions of the '279 and '671 disclose an ultra-slim brushless electric machine comprising a stator provided with driving coils formed in the PCB and a rotor with a plurality of permanent magnets.

There is a long-felt and unmet need for ultra-slim brushless electric machine devices characterized by the simplicity of electric circuitry and reliability improvement, which can be easily mass produced.

### SUMMARY OF THE INVENTION

It is hence one object of the invention to disclose an axial-flux electric machine comprising: (a) a stator provided with at least one flat winding; and (b) a rotor carrying a plurality of circumferentially distributed permanent magnets; the rotor rotatably connected to the stator with a radial air gap.

It is a core purpose of the invention to provide the flat winding which is circumferentially distributed over the stator. The flat winding comprises a plurality of petal-like sections being substantially radial relative to an axis of the rotor.

Another object of the invention is to disclose the flat winding formed by a process selected from the group consisting of a printed circuit board process, photochemical etching, chemical etching, mechanical tooling, multi or single-layer wire winding, casting and any combination thereof.

A further object of the invention is to disclose a number of the petal-like sections which is equal to or multiple of a number of the permanent magnets.

A further object of the invention is to disclose the stator comprises a multi-winding structure; each winding is individually layered within the multi-winding structure.

A further object of the invention is to disclose the electric machine configured for polyphase supply; each winding placed on the individual layer is connectable to a corresponding phase.

A further object of the invention is to disclose the electric machine comprising plurality of the windings which are connectable to one phase.

A further object of the invention is to disclose the windings are connectable to the phase in series or in parallel.

A further object of the invention is to disclose the electric machine having coaxially disposed plurality of said stators and plurality of said rotors interlayered therebetween.

A further object of the invention is to disclose the radial sections are split.

A further object of the invention is to disclose the stator incorporated into an electric machine selected from the group consisting an AC motor, a DC motor, an AC generator, a DC generator, a brush-type motor, a brush-type generator, a brushless motor, a brushless generator, an induction motor, a switched reluctance motor, a salient pole motor, a stepping motor, a synchronous motor, an asynchronous motor, a resolver, a tachometer, a permanent magnet motor, and a permanent magnet generator.

A further object of the invention is to disclose the electric machine further comprising a rotor selected from the group consisting of a permanent magnet rotor, a wound rotor, a salient pole rotor, a ferromagnetic back-plate and any combination thereof.

A further object of the invention is to disclose the rotor provided with two pluralities of magnets embracing said stator both sides.

A further object of the invention is to disclose the stator provided with two said flat windings embracing said rotor both sides.

A further object of the invention is to disclose a method of using a flat winding stator in an axial-flux electric machine. The aforesaid method comprises the steps of (a) providing a stator provided with at least one flat winding; the flat winding comprises a plurality of petal-like sections being substantially radial relative to an axis of the rotor; (b) providing a rotor or rotor pair carrying a plurality of circumferentially distributed permanent magnets: (c) rotatably placing the rotor onto the stator with a radial air gap; (d) energizing the flat winding; (e) providing an rotational torque.

It is a core purpose of the invention to provide a rotational torque created by the plurality of being substantially radial petal-like sections.

A further object of the invention is to disclose a method of using a flat winding stator in an axial-flux electric machine. The aforesaid method comprises the steps of (a) providing a stator provided with at least one flat winding; the flat winding is circumferentially distributed over the stator; the flat winding comprises a plurality of petal-like sections being substantially radial relative to an axis of the rotor; (b) providing a rotor carrying a plurality of circumferentially distributed permanent magnets; (c) rotatably placing said rotor or rotor pair onto said stator with a radial air gap; (d) applying a rotational torque to the rotor; (e) generating electrical voltage at terminals of said flat winding;

It is a core purpose of the invention to provide the voltage created within said plurality of substantially radial petal-like sections.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic cross-sectional view of the axial-flux electric machine;

FIGS. 2 and 3 are schematic views of the flat stator windings; and

FIG. 4 is a detailed schematic view of the connection terminal of the stator winding.

### DETAILED DESCRIPTION OF THE INVENTION

The following description is provided so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide an axial flux electric machine provided with flat stator winding and a method of using the same.

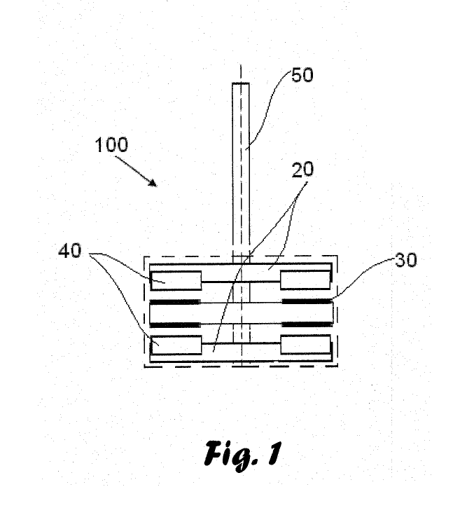

Reference is now made to FIG. 1, presenting a schematic view of an axial-flux electric machine 100 comprising a stator 10 and a rotor 20 rotatably connected to the stator 10. The rotor 20 is provided with a circumferentially distributed plurality of permanent magnets 40. A flat winding 30 is placed inside the stator 10. The flat winding 30 is integrally configured for concurrent interaction with whole plurality of the permanent magnets 40.

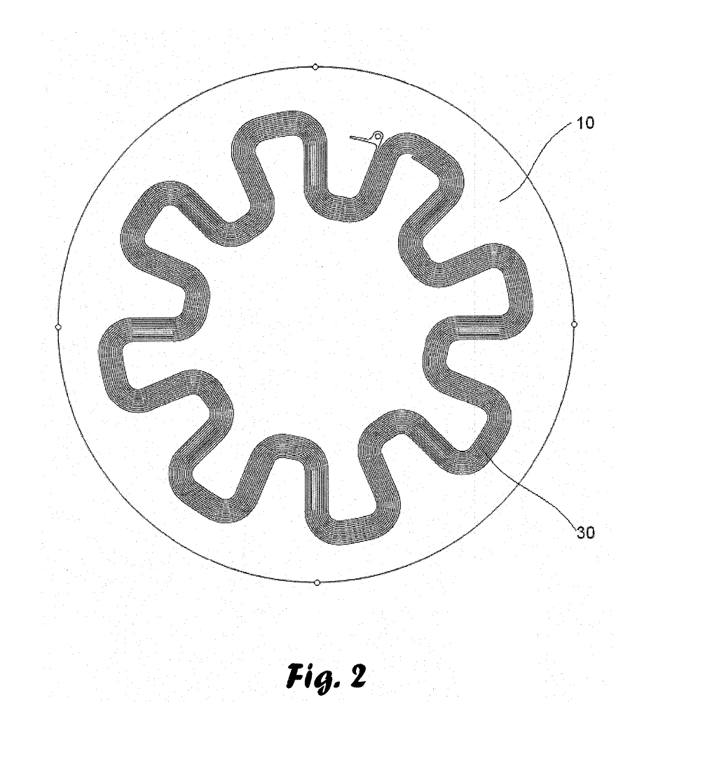

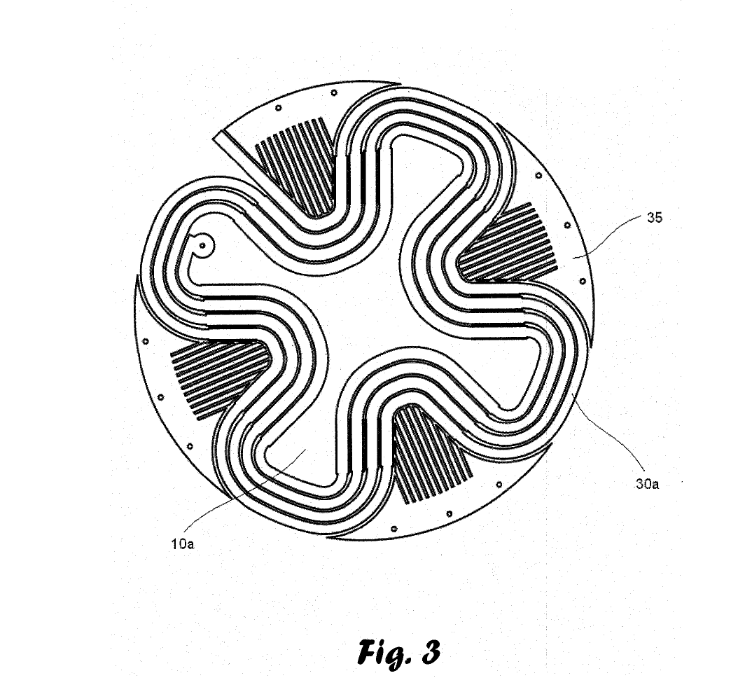

Reference is now made to FIG. 2, presenting a schematic view of the flat winding 30 placed on the stator 10. The flat winding 30 is circumferentially distributed over the stator. The flat winding comprises a plurality of petal-like sections being substantially radial relative to an axis of said rotor. A number of the petal-like sections is equal to or multiple of a number of said permanent magnets. The aforesaid petal sections create a magnetic field similar to the magnetic fields of individual electromagnets known in the art. However, the proposed winding configuration is simpler in terms of technological process of mass production and provides high reliability of the electric machine integrally.

In accordance with one embodiment of the current invention, the stator comprises a multi-winding structure. Each winding is formed within an individual layer of the flat stator.

The electric machine can be configured for polyphase supply. Each winding placed on said individual layer is connectable to a corresponding phase in series or in parallel.

Reference is now made to FIG. 2, presenting an alternative embodiment of a flat winding 30a placed on the stator 10a. The flat winding 30a is provided with a heat sink for heat transfer 35.

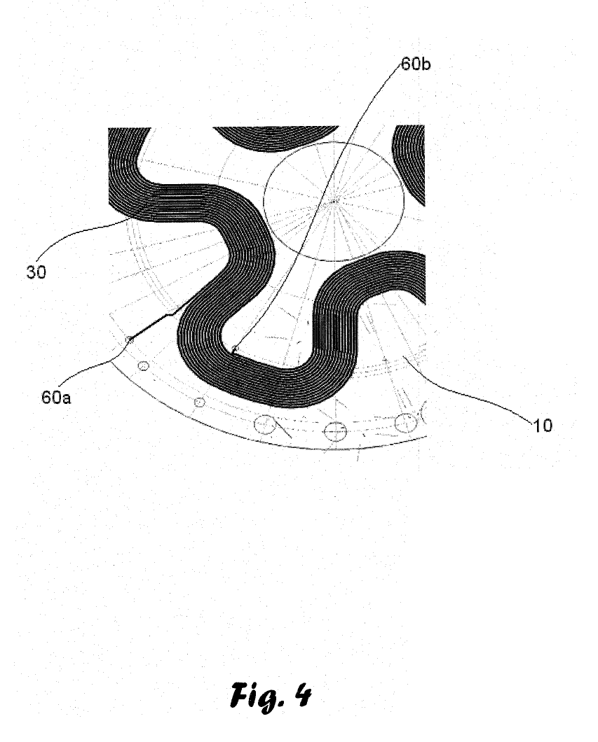

Reference is now made to FIG. 4, presenting a detailed schematic view of PCB winding 30 provided with connecting terminals 60a and 60b

The proposed technical solution provides an ultra-thin electric machine. Modularity and stackability of the machine design allows splitting of the single stator between several rotors such that one stator interacts with several magnetic fields created by permanent magnets of the rotors. The splitting can be achieved either by placing each phase winding in between rotor pair or by placing windings of all three phases in between each rotor pair.

Torque constant Kₜ, and back-EMF constant Kₑ can easily be varied during machine operation by means of switching between connection in parallel and in series using simple switching electronics

The proposed technical solution provides improved modularity and stackability of both the stator in a specific manner, and of the machine en bloc. The stators can be easily connected in various commutation schemes. Machines can be stacked easily into powerful multi-stage machines with high power to volume ratio.

Stator is constructed of a stack of layers. Each layer contains a winding segment that belongs to a single phase. The layers are then interconnected to create flexible winding circuitry adapted for single or multi-phase supply.

Winding topology is characterized by circumferentially distributed “petals”. Different layer and petals numbers are in the scope of the current invention. The proposed approach provides stator winding arrangements for different pole counts and applications according to required machine performance (torque, speed, efficiency). Inter-phase connection at “delta” having three pairs of connection points or “star” with one connection pair points is achieved by inter-layer soldering in a manner the does not increase total stator thickness.

Topology allows inter-phase connections to be located internally in stator. Layers can be connected in series or parallel according to a number of the required turns. Each layer is electrically insulated by an insulating material placed between layers or by insulating coating, or an electro-static painting or other means. Alternatively, each layer can be produced using PCB technology or by using enameled or coated wire.

The multilayer structure can then be encapsulated in an encapsulating matrix (such as epoxy or other material) for providing rigidity, heat transfer and further electrical insulation. Alternatively, the aforesaid stator structure can made according to traditional PCB technology. Interlayer connections are done “via” through-hole soldering. Inter-layer insulation is achieved inherently by PCB technology. In this case, electro-static insulation and epoxy encapsulations are not necessary.

The proposed topology can minimize eddy-currents by longitudinally splitting radial conductors. Additionally, the proposed topology may provide conductors of variable width to reduce ohmic resistance, where applicable.

1-37. (canceled)

38. A stator for an axial-flux electric machine; wherein said stator provided with at least one flat winding formed thereon;
said flat winding is circumferentially distributed over said flat stator; said flat winding comprises a plurality of petal-like sections being substantially radial relative to an axis of said rotor.

39. The stator according to claim 38, provided with a plurality of said flat layered windings circumferentially distributed over said flat stator.

40. The stator according to claim 38, wherein said stator is of a core type.

41. The stator according to claim 38, wherein said stator is coreless.

42. The stator according to claim 38, wherein flat winding is formed by a process selected from the group consisting of a printed circuit board process, photochemical etching, chemical etching, mechanical tooling, multi or single-layer wire winding, casting and any combination thereof.

43. The stator according to claim 38, wherein said stator comprises a multi-winding structure; each winding is formed within an individual layer of said flat stator.

44. The stator according to claim 43, configured for polyphase supply; each winding placed on said individual layer is connectable to a corresponding phase.

45. The stator according to claim 43, comprising plurality of said windings which are connectable to one phase.

46. The stator according to claim 43, wherein said windings are connectable to said phase in series.

47. The stator according to claim 43, wherein said windings are connectable to said phase in parallel.

48. The stator according to claim 43, adapted for variation of output torque constant Kₜ, and back-EMF constant Kₑ by means of change in the connection scheme of windings.

49. The stator according to claim 38, having coaxially disposed plurality of said stators and plurality of said rotors interlayered therebetween.

50. The stator according to claim 38, wherein said radial sections are split.

51. The stator according to claim 38, provided with two said flat windings embracing said rotor both sides.

52. The stator according to claim 38, comprising a substrate provided with two said windings; said windings are connected in series by means of an interwinding connection.

53. The stator according to claim 38, incorporated into an electric machine selected from the group consisting an AC motor, a DC motor, an AC generator, a DC generator, a brush-type motor, a brush-type generator, a brushless motor, a brushless generator, an induction motor, a switched reluctance motor, a salient pole motor, a stepping motor, an asynchronous motor, a synchronous motor, a resolver, a tachometer, a permanent magnet motor, and a permanent magnet generator.

54. The stator according to claim 50, wherein said electric machine further comprises a rotor selected from the group consisting of a permanent magnet rotor, a wound rotor, a salient pole rotor, a ferromagnetic back-plate and any combination thereof.

55. The stator according to claim 51, wherein said rotor is provided with two pluralities of magnets embracing said stator both sides.

56. A method of using a flat winding stator in an axial-flux electric machine; said method comprising the steps of:
(a) providing a stator;
(b) providing a rotor carrying a plurality of circumferentially distributed permanent magnets;
(c) rotatably placing said rotor or rotor pair onto said stator with a radial air gap;
(d) energizing said flat winding;
(e) providing a rotational torque;
wherein at said rotational torque is created by at least one stator flat winding of substantially radial petal-like shape.

57. A method of using a flat winding stator in an axial-flux electric machine; said method comprising the steps of:
(a) providing a stator provided with at least one flat winding; said flat winding is circumferentially distributed over said stator; said flat winding comprises a plurality of petal-like sections being substantially radial relative to an axis of said rotor;
(b) providing a rotor carrying a plurality of circumferentially distributed permanent magnets;
(c) rotatably placing said rotor or rotor pair onto said stator with a radial air gap;
(d) applying a rotational torque to said rotor;
(e) generating electrical voltage at terminals of said flat winding;
wherein said voltage is created within at least one flat winding of substantially radial petal-like shape.
